(19) United States
(12) Patent Application Publication
(10) Pub. No.: US 2011/0002190 A1
(43) Pub. Date: Jan. 6, 2011

(54) Fiber Feed System For Extruder For Use In Filled Polymeric Products

(75) Inventor: Marc-Andre Tardif, Atlanta, GA (US)

Correspondence Address: McKeon Meunier Carlin & Curfman LLC, 817 W. Peachtree Street, Suite 900, Atlanta, GA, 30308, US

(73) Assignee: Boral Material Technologies Inc., San Antonio, TX (US)

(21) Appl. No.: 12/830,747

(22) Filed: Jul. 6, 2010

Related U.S. Application Data
(60) Provisional application No. 61/223,187, filed on Jul. 6, 2009.

(51) Int. Cl. B01F 15/04

(52) U.S. Cl. 366/160.1

(57) ABSTRACT

Methods for forming composite materials containing fiber in an extruder are described. A first method includes introducing a polymeric material, an inorganic filler, and a fiber to an extruder. A fiber metering device is used to control the rate the fiber is introduced to the extruder based on the extrusion rate of the extruder. A further method is described that includes introducing a polymeric material and an inorganic filler to an extruder. Then, downstream of the polymeric material and inorganic filler, a fiber metering device introduces a constant weight percentage of fiber to the extruder based on the amount of polymeric material and inorganic filler introduced to the extruder. After the polymeric material, inorganic filler, and fiber are introduced to the extruder by either method, the components are mixed to produce a composite material.

### CROSS-REFERENCE TO RELATED APPLICATIONS

The present application claims priority to U.S. Provisional Patent Application No. 61/223,187, filed Jul. 6, 2009, which is incorporated herein by reference in its entirety.

### BACKGROUND

Fibrous materials can be added to polymer compositions. When added, fibers can, for example, improve the strength or flexibility of a polymer composition. In an extrusion process, the added fibers can be long and continuous or short and fragmented and the fibers can be intentionally or randomly oriented.

### SUMMARY

Methods for forming composite materials containing fiber in an extruder are described herein. A first method for forming a composite material in an extruder includes introducing a polymeric material, an inorganic filler, and a fiber to an extruder. The fiber is introduced to the extruder through a fiber metering device, which controls the rate the fiber is introduced to the extruder to be proportional to the extrusion rate of the extruder. After the polymeric material, inorganic filler, and fiber are introduced to the extruder, the components are mixed to produce a composite material. The polymeric material can be a thermosetting or thermoplastic polymer. The polymeric material can be a polyurethane made in situ in the extruder.

An additional method for forming a composite material in an extruder includes introducing a polymeric material and an inorganic filler to an extruder. Then, downstream of the polymeric material and inorganic filler, a fiber can be introduced in a controlled rate through a fiber metering device. The fiber metering device providing a constant weight percentage of fiber in the composite material based on the amount of polymeric material and inorganic filler introduced to the extruder. And after the polymeric material, inorganic filler, and fiber are introduced to the extruder, the components can be mixed to produce a composite material. The polymeric material can be a thermosetting or thermoplastic polymer. The polymeric material can be a polyurethane made in situ in the extruder.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic of an extruder system with a fiber metering device.

FIG. 2A is a schematic showing a pulley used as a fiber metering device.

FIG. 2B is a schematic showing a pulley/motor combination used as a fiber metering device.

FIG. 2C is a schematic showing a pulley/fiber retarder combination used as a fiber metering device.

FIG. 3 is a schematic showing a control system for a fiber metering device.

Like reference symbols in the various drawings indicate like elements.

### DETAILED DESCRIPTION

Methods for forming composite materials containing fiber in an extruder are described herein. One method includes introducing a polymeric material, an inorganic filler, and a fiber to an extruder. The fiber is introduced to the extruder through a fiber metering device, which controls the rate the fiber in introduced to the extruder. After the polymeric material, inorganic filler, and fiber are introduced to the extruder, the components are mixed to produce a composite material. A further method includes introducing a polymeric material and an inorganic filler to an extruder. Then, downstream of the polymeric material and inorganic filler, a fiber can be introduced in a controlled rate through a fiber metering device. The fiber metering device providing a constant weight percentage of fiber in the composite material based on the amount of polymeric material and inorganic filler introduced to the extruder. After the polymeric material, inorganic filler, and fiber are introduced to the extruder, the components are mixed to produce a composite material.

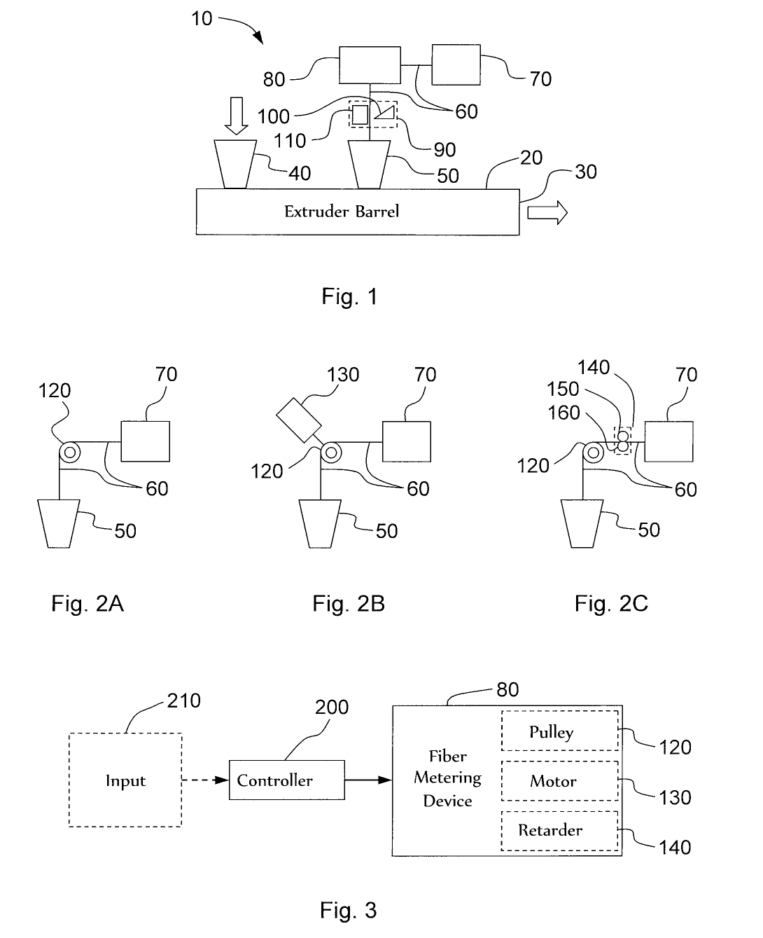

Components of an extruder system 10 useful in implementing the methods described herein are shown in FIG. 1. Extruder system 10 includes an extruder barrel 20 with an outlet end 30, a first input 40, and a second input 50. Polymeric material and inorganic filler are introduced to the extruder system 10 through the first input 40. Fiber 60 is introduced to the extruder system 10 through the second input 50. Before fiber 60 is introduced to the second input 50 from a fiber source 70, it is metered by the fiber metering device 80, and cut by a fiber cutter 90 (the fiber cutter comprising a cutting element 100 and a backing element 110).

The fiber metering device 80 can include one or more of a pulley, a motor, or a fiber retarder. Fiber metering devices utilizing a pulley 120 are shown in FIGS. 2A-2C. A pulley 120 can be used to orient a fiber 60, control the feed direction of the fiber 60, and/or control the rate the fiber 60 is fed. A pulley 120 useful with the invention can include a circumferential groove through which the fiber 60 travels. A pulley 120 can be, for example, free turning or controlled. A free turning pulley allows the fiber to travel at whatever speed it is fed to or pulled from the pulley by forces external to the pulley. A free turning pulley can include a bearing or other friction reducing device. A controlled pulley can actively reduce or increase the speed of a fiber 60 or passively allow the fiber to travel at whatever speed it is fed to or pulled from the pulley, i.e., operate in a free turning mode. To actively reduce or increase the speed of a fiber 60, the pulley pulls or pushes the fiber 60 through frictional or other controlling forces. As an example, a frictional force can be created between the fiber 60 and the pulley 120 by providing a rubberized contact surface on the pulley 120.

A fiber metering device including a pulley 120 and a motor 130 is shown in FIG. 2B. In the fiber metering device shown in FIG. 2B, the pulley 120 is controlled by the motor 130. In this configuration, the motor 130 controls the rate at which the fiber 60 is fed into the second input 50. The speed of the motor 130 can act to reduce or increase the speed of the fiber 60 fed into the second input 50 through the interaction of the fiber 60 with the pulley 120. To reduce or increase the speed of a fiber 60, the pulley pulls or retards the fiber 60 through frictional or other controlling forces.

A fiber metering device including a pulley 120 and a fiber retarder 140 is shown in FIG. 2C. In the fiber metering device shown in FIG. 2C, the pulley 120 is a free turning pulley and the fiber retarder 140 controls the rate the fiber passes over the pulley 120 and into the second input 50. As shown in FIG. 2C, the fiber retarder 140 includes an upper roller 150 and a lower roller 160. The upper roller 150 and lower roller 160 interact with the fiber 60 through frictional or other forces. As an example, a frictional force can be created between the fiber 60 and the pulley 120 by providing a rubberized contact surface on one or more of the upper roller 150 and lower roller 160.

The fiber metering device 80 determines the rate the fiber 60 is introduced to the extruder 10. The fiber metering device 80 can base the rate at which the fiber 60 is introduced to the extruder 10 (i.e., fed into the second input 50) on the extrusion rate of the extruder 10 or the rotational velocity of a screw of the extruder 10. Similarly, the fiber metering device 80 can base the rate at which the fiber 60 is introduced to the extruder 10 on the rate (or an estimate of the rate) that the polymeric material and inorganic filler materials advance through the extruder 10; the rate (or an estimate of the rate) that the polymeric composite material exits the extruder; or the rate (or an estimate of the rate) that the polymeric material and inorganic filler materials are added to the extruder. Another method for determining a rate to introduce the fiber 60 to the extruder is based on loss of weight of the fiber source. For example, if the weight per unit length of a fiber is known, the length of fiber fed to an extruder per a unit of time (i.e., the rate) can be determined by monitoring weight loss over time. For further example, the fiber source can be a spindle and the weight of the spindle can be monitored to determine the rate the fiber 60 is fed to the extruder 10 in a set amount of time.

The methods described herein can include a step of determining an extrusion rate of the extruder 10 and setting the rate the fiber 60 is introduced to the extruder 10 based on the extrusion rate. The methods described herein can also include a step of monitoring an extrusion rate of the extruder 10 and changing the rate the fiber 60 is introduced to the extruder 10 based on the extrusion rate. The methods described herein can further include a step of determining the amount of polymeric material and inorganic filler being introduced to the extruder and setting the rate the fiber is introduced to the extruder based on the amount of polymeric material and inorganic filler being introduced to the extruder. The methods described herein can additionally include a step of monitoring the amount of polymeric material and inorganic filler being introduced to the extruder and changing the rate the fiber is introduced to the extruder based on any changes in the amount of polymeric material and inorganic filler being introduced to the extruder. If a pulley 120 is used, the rate the fiber 60 is introduced to the extruder 10 can be determined based on the rotational speed of the pulley 120.

The amount of fiber 60 added to a composite using the methods described herein can, for example, comprise about 0.1 to about 15 weight percent of fiber, which includes, for example, approximately 0.1, 0.2, 0.3, 0.4, 0.5, 0.6, 0.7, 0.8, 0.9, 1, 1.5, 2, 3, 4, 5, 6, 7, 8, 9, 10, 11, 12, 13, 14, or 15 weight percent of fiber. These amounts may be based on the total of all of the fibers, such as one or more of rovings and linear tows. However, the fiber values may also be representative of only one type of fiber, e.g., rovings. In certain embodiments, the polymeric composite material may contain the fiber in an amount within a range formed by two of the foregoing approximate weight percents. Additionally, the composite materials can comprise between 0.5 and 10 weight percent of fiber, between 1 and 8 weight percent of fiber, between 1.5 and 7 weight percent of fiber, or between 2 and 6 weight percent of fiber.

The length of fiber segments added to a composite is determined by the fiber cutter 90. The fiber cutter 90 shown in FIG. 1 includes a cutting element 100 and a backing element 110. Other fiber cutters are known to those of skill in the art. The length to which a fiber is cut will depend upon the specific properties desired in the urethane composite material being formed. While the extruder system 10 shown in FIG. 1 includes a fiber cutter 90, a fiber metering device 80 can be used in an extruder system without a fiber cutter. For example, a fiber can be continuously fed into an extruder barrel in such a manner that the fiber is cut into pieces by the actions of a screw in the extruder barrel. Similarly, a fiber can be continuously fed into an extruder barrel in such a manner that the fiber remains continuous (i.e., is not cut).

As shown in FIG. 3, a controller 200 can be used to control the fiber metering device 80. The controller 200 is operatively interconnected with the fiber metering device 80. The controller 200 can be operatively interconnected with one or more of the pulley 120, the motor 130, and the fiber retarder 140. The controller 200 has hardware and/or software configured for operation of these components (80, 120, 130, and 140), and may comprise any suitable programmable logic controller or other control device, or combination of control devices, that is programmed or otherwise configured to perform as recited in the claims. The controller 200 can control the fiber metering device based on an input signal 210. The input signal 210 can be the rate the fiber 60 is introduced to the extruder 10, e.g., the extrusion rate. Additionally, the input signal 210 can be one of the extrusion rate of the extruder or an estimate thereof; the rotational velocity of a screw of the extruder or an estimate thereof; the rate the polymeric material and inorganic filler materials advance through the extruder or an estimate thereof; the rate the polymeric composite material exits the extruder or an estimate thereof; or the rate the polyol, di- or poly-isocyanate, and inorganic filler materials are added to the extruder or an estimate thereof.

Various thermosetting and thermoplastic polymeric composite materials may be created using an extruder and the methods described herein. Extrusion allows for thorough mixing of the various components of the polymeric composite material. The extruder components may be configured in various ways to provide a substantially homogeneous mixture of the various components of the polymeric composite material. Pre-formed polymers can be added to the extruder for mixing, or components to create a polymer can be added individually in proportions such that polymerization will occur in the extruder, i.e., in situ. When a polymer is formed in situ, the various components may be added in different orders and at different positions in an extruder (e.g., through hoppers, feed chutes, or side feeders). As used herein, the term polymeric material is intended to include the components of a polymeric material made in situ in an extruder. Hence, a method step referring to adding a polymeric material to an extruder includes the addition of components that will react to form a polymeric material in situ in an extruder. The various materials added to an extruder may be metered into the extruder through metering devices or other means. Continuous feeding of the respective components of the polymeric composite material results in a continuous process of extruding the polymeric composite material. Extruder technology is well known to those of skill in the art.

Polyurethane polymers are useful as the polymeric material in the present methods. Polyurethanes can be created in situ in an extruder, for example, by combining one or more monomeric or oligomeric poly- or di-isocyanates (sometimes referred to as “isocyanate”) and one or more polyols, such as a polyester polyol or a polyether polyol. Such reactions may be controlled by various additives and reaction conditions. For example, surfactants may be used to control cell structure and catalysts may be used to control reaction rates. An example of a polyurethane composite material formed in situ may include one or more of a polyol, a monomeric or oligomeric di- or poly-isocyanate, an inorganic filler, a fibrous materials, a catalyst, a surfactant, a colorant, a coupling agent, and other various additives.

Fillers as used with the methods described herein include particulate material. With the addition of such fillers, the composite materials may still retain good chemical and mechanical properties. These properties of the composite material allow for its use in building materials and other structural applications. Advantageously, the composite material may contain large loadings of filler content without substantially sacrificing the intrinsic structural, physical, and mechanical properties of the polymer. Examples of fillers useful with the compositions described herein include, but are not limited to, fly ash and bottom ash; wollastonite; ground waste glass; granite dust; calcium carbonate; perlite; barium sulfate; slate dust; gypsum; talc; mica; montmorillonite minerals; chalk; diatomaceous earth; sand; bauxite; limestone; sandstone; microspheres; porous ceramic spheres; gypsum dihydrate; calcium aluminate; magnesium carbonate; ceramic materials; pozzolanic materials; zirconium compounds; vermiculite; pumice; zeolites; clay fillers; silicon oxide; calcium terephthalate; aluminum oxide; titanium dioxide; iron oxides; calcium phosphate; sodium carbonate; magnesium sulfate; aluminum sulfate; magnesium carbonate; barium carbonate; calcium oxide; magnesium oxide; aluminum hydroxide; calcium sulfate; barium sulfate; lithium fluoride; calcium hydroxide; and other solid waste materials. Other acceptable fillers will be known to those of skill in the art. Fly ash is useful because it is uniform in consistency and contains carbon, which can provide some desirable weathering properties to the product due to the inclusion of fine carbon particles which are known to provide weathering protection to plastics, and the effect of opaque ash particles which block UV light. Ground glass (such as window or bottle glass) is also useful as it absorbs less resin, decreasing the cost of the composite.

Particulate materials with a broad particle size distribution having multiple modes can advantageously be used with the composites described herein. Examples of such particulate materials can be found in U.S. Pat. Nos. 6,916,863 and 7,241,818, which are incorporated herein by reference in their entirety. Specifically, a fly ash filler or filler blend having a particle size distribution with at least three modes can be used. Preferably, the particle size distribution includes a first mode having a median particle diameter from 0.3 to 1.0 microns, a second mode having a median particle diameter from 10 to 25 microns, and a third mode having a median particle diameter from 40 to 80 microns. The particle size distribution also preferably includes 11-17% of the particles by volume in the first mode, 56-74% of the particles by volume in the second mode, and 12-31% of the particles by volume in the third mode. Moreover, the ratio of the volume of particles in the second and third modes to the volume of particles in the first mode is preferably from about 4.5 to about 7.5. A filler comprising a fly ash having a particle size distribution having at least three modes can further include one or more additional fillers other than the fly ash.

The composite materials described herein additionally comprise blends of various fillers. For example, coal fly ash and bottom ash can be used together as a mixture. Composite materials utilizing filler blends may exhibit better mechanical properties such as impact strength, flexural modulus, and flexural strength. A further advantage in using filler blends is compatibility in particle size distribution that can result in higher packing ability in certain blends.

The composite materials described herein can comprise about 20 to about 95 weight percent of inorganic filler, which includes, for example, approximately 20, 25, 30, 35, 40, 42, 44, 46, 48, 50, 52, 54, 56, 58, 60, 62, 64, 66, 68, 70, 72, 74, 76, 78, 80, 82, 84, 86, 88, 90, 92, or 94 weight percent of filler. These amounts may be based on the total of all of the fillers, such as one or more of fly ash and dust. However, the filler values may also be representative of only one type of filler, e.g., fly ash. In certain embodiments, the polymeric composite material may contain the filler in an amount within a range formed by two of the foregoing approximate weight percents. Additionally, the composite materials can comprise about 30 to about 90 weight percent of inorganic filler, about 40 to about 87.5 weight percent of inorganic filler, about 50 to about 85 weight percent of inorganic filler, about 60 to about 82.5, or about 65 to about 80 weight percent of inorganic filler. As used herein, weight percent refers to the relative weight of the filler component compared to the total weight of the composite material.

The addition of fibers are described herein is also made such that the composite materials will retain good chemical and mechanical properties as described regarding the use of fillers. Fibers useful with the present invention can include fibers, such as chopped glass, PVA, carbon, basalt and wollastonite fibers (chopped before or during mixing in an extruder), rovings, linear tows, or fabrics. The reinforcing fibers can range in length, for example, from about 0.1 in. to about 2.5 in, from about 0.2 in to about 2 in., from about 0.25 in. to about 1 in., or from about 0.25 in. to about 0.5 in. Such fibers can, for example, be wrapped around a spindle or otherwise contained as known to those of skill in the art.

The reinforcing fibers give the material added strength (flexural, tensile, and compressive), increase its stiffness, and provide increased toughness (impact strength or resistance to brittle fracture). The use of rovings or tows increases flexural stiffness and creep resistance. Specifically, the dispersed reinforcing fibers may be bonded to the polymeric matrix phase, thereby increasing the strength and stiffness of the resulting material. This enables the material to be used as a structural synthetic lumber, even at relatively low densities (e.g., about 20 to about 60 lb/ft³).

Composite materials as described herein may be formed with a desired density, even when foamed, to provide structural stability and strength. In addition, the composite materials can be easily tuned to modify its properties by, e.g., adding oriented fibers to increase flexural stiffness, or by adding pigment or dyes to hide the effects of scratches. Also, such composite materials may also form a “skin,” i.e., a tough, slightly porous layer that covers and protects the more porous material beneath. Such skin is tough, continuous, highly adherent and provides excellent water and scratch resistance.

While, thermosetting and thermoplastic polymeric composite materials may be created using the methods described herein, the various components of polyurethane composite materials are further described. As discussed above, one of the monomeric components used to form a polyurethane polymer for use in the composite material is monomeric or oligomeric poly or di-isocyanate (an aromatic diisocyanate or polyisocyanate may be used). In certain embodiments methylene diphenyl diisocyanate (MDI) is used. The MDI can be MDI monomer, MDI oligomer, or mixtures thereof. The particular MDI used can be selected based on the desired overall properties, such as the amount of foaming, strength of bonding to the inorganic particulates, wetting of the inorganic particulates in the reaction mixture, strength of the resulting composite material, and stiffness (elastic modulus).

Suitable MDI compositions include those having viscosities ranging from about 25 to about 200 cp at 25° C. and NCO contents ranging from about 30% to about 35%. Generally, isocyanates are used that provide at least 1 equivalent NCO group to 1 equivalent OH group from the polyols, preferably with about 5% to about 10% excess NCO groups. Suitable examples of aromatic polyisocyanates include 4,4-diphenylmethane diisocyanate (methylene diphenyl diisocyanate), 2,4- or 2,6-toluene diisocyanate, including mixtures thereof, p-phenylene diisocyanate, tetramethylene and hexamethylene diisocyanates, 4,4-dicyclohexylmethane diisocyanate, isophorone diisocyanate, mixtures of 4,4-phenylmethane diisocyanate and polymethylene polyphenylisocyanate. In addition, triisocyanates such as, 4,4,4-triphenylmethane triisocyanate; 1,2,4-benzene triisocyanate; polymethylene polyphenyl polyisocyanate; and methylene polyphenyl polyisocyanate, may be used. Isocyanates are commercially available from Bayer Corporation (Pittsburgh, Pa.) under the trademarks MONDUR and DESMODUR. Isocyanates suitable for use with the composites described herein include Bayer MRS-4, Bayer MR Light, Dow PAPI 27 (Dow Chemical Company; Midland, Mich.), Bayer MR5, Bayer MRS-2, and Huntsman Rubinate 9415 (Huntsman Polyurethanes; Geismar, La.).

As indicated above, the isocyanate is reacted with one or more polyols. In general, the ratio of isocyanate to polyol (isocyanate index), based on equivalent weights (OH groups for polyols and NCO groups for isocyanates) is generally in the range of about 0.5:1 to about 1.5:1. Additionally, the isocyanate index can be from about 0.8:1 to about 1.1:1, from about 0.8:1 to about 1.2:1, or from about 1.05:1 to about 1.1:1. Ratios in these ranges provide good foaming and bonding to inorganic particulates, and yields low water pickup, fiber bonding, heat distortion resistance, and creep resistance properties. A particularly useful isocyanate index is from 1.05:1 to 1.1:1.

Polyols useful with the methods described herein may be single monomers, oligomers, or blends. Mixtures of polyols can be used to influence or control the properties of the resulting composite material. The properties, amounts, and number of polyols used may be varied to produce a desired polyurethane composite material. Useful polyols include polyester and polyether polyols. Polyether polyols are commercially available from, for example, Bayer Corporation (Pittsburg, Pa.) under the trademark MULTRANOL. Polyols useful with the methods described herein include polyether polyols, such as MULTRANOL, including MULTRANOL 3400 and MULTRANOL 4035, ethylene glycol, polypropylene glycol, polyethylene glycol, diethylene glycol, triethylene glycol, dipropylene glycol, glycerol, 2-pentane diol, pentaerythritol adducts, 1-trimethylolpropane adducts, trimethylolethane adducts, ethylenediamine adducts, diethylenetriamine adducts, 2-butyn-1,4-diol, neopentyl glycol, 1,2-propanediol, pentaerythritol, mannitol, 1,6-hexanediol, 1,3-buytylene glycol, hydrogenated bisphenol A, polytetramethyleneglycolethers, polythioethers, and other di- and multi-functional polyethers and polyester polyethers, and mixtures thereof. Additionally, plant-based polyols (such as castor, canola, and soy oil polyols), polycarbonate polyols, phenolic polyols, and acrylic polyols can be used. Examples of plant based polyols useful with the methods described herein include ECOPOL 122, ECOPOL 123, ECOPOL 124, ECOPOL 131, and ECOPOL 132, which are aromatic polyester polyols based on soybean oil grafted with polyethylene terephthalate (PET) from ECOPUR Industries Inc. (Dallas, Tex.).

Additional components useful with polyurethanes include chain-extenders, cross-linkers, blowing agents, UV stabilizers, anti-oxidants, pigments, coupling agents, surfactants, and catalysts. Though the use of such components is well known to one of skill in the art, some of these additional additives are further described herein.

Low molecular weight reactants such as chain extenders and/or cross linkers can be included in the polyurethane composite materials described herein. These reactants help the polyurethane system to distribute and contain the inorganic filler and/or fibers within the polyurethane composite material. Chain extenders are difunctional molecules, such as polyols or amines, that can polymerize to lengthen the urethane polymer chains. Examples of chain extenders include the 1,4-butane diol; 4,4′-Methylenebis (2-Chloroaniline) (MBOCA); and diethyltoluene diamine (DETDA). Cross-linkers are tri- or greater functional molecules that can integrate into a polymer chain through two functionalities and provide one or more further functionalities (i.e., linkage sites) to cross-link to additional polymer chains. Examples of chain extenders include ethylene glycol, glycerin, trimethylolpropane, glycerol, and sorbitol. In some polyurethane composites, a cross linker or chain extender may be used to replace a portion of the polyol.

Blowing (foaming) agents may also be added to the reaction mixture if a foamed product is desired. Examples of blowing agents include organic blowing agents, such as halogenated hydrocarbons, hexanes, and other materials that vaporize when heated by the polyol-isocyanate reaction (such as water, which reacts with isocyanate to yield carbon dioxide).

Ultraviolet light stabilizers, such as UV absorbers, can be added to the polyurethane composite material. Examples of UV light stabilizers include hindered amine type stabilizers and opaque pigments like carbon black powder. Antioxidants, such as phenolic antioxidants can also be added. Antioxidants provide increased UV protection, as well as thermal oxidation protection.

Pigments or dyes optionally can be added to the polyurethane composite material. An example of a pigment is iron oxide, which can be added in amounts ranging from about 2 wt % to about 7 wt %, based on the total weight of the composite material.

Catalysts are generally added to control the curing time of the polymer matrix. Examples of useful catalysts include amine-containing catalysts (such as DABCO and tetramethylbutanediamine) and tin-, mercury-, and bismuth-containing catalysts. Multiple catalysts can be used to increase uniformity and rapidity of cure. For example, a mixture of 1 part tin-containing catalyst to 10 parts amine-containing catalyst can be added to a reaction mixture in an amount up to about 0.10 wt % (based on the total reaction mixture).

Surfactants may optionally be used as wetting agents and to assist in mixing and dispersing the inorganic particulate material in a composite. Surfactants also stabilize and control the size of bubbles formed during foaming (if foaming is used) and passivates the surface of the inorganic particulates, so that the polymeric matrix covers and bonds to a higher surface area. Surfactants can be used in amounts below about 0.5 wt % based on the total weight of the mixture. Examples of surfactants useful with the polyurethanes described herein include silicone surfactants such as DC-197 and DC-193 (Air Products; Allentown, Pa.), and other nonpolar and polar (anionic and cationic) products.

Coupling agents and other surface treatments such as viscosity reducers or flow control agents can be added directly to the filler or fiber (pre-treatment), or incorporated prior to, during, and/or after the mixing and reaction of the polyurethane composite material. Coupling agents allow higher filler loadings of an inorganic filler such as fly ash and may be used in small quantities. For example, the polyurethane composite material may comprises about 0.01 wt % to about 0.5 wt % of a coupling agent. Examples of coupling agents useful with the polyurethanes described herein include Ken-React LICA 38 and KEN-React KR 55 (Kenrich Petrochemicals; Bayonne, N.J.).

Variations in the ratio of the polyol to the isocyanate in a reactive mixture may result in variations in the polyurethane composite especially with high inorganic filler loads. Additionally, changes in the polyol to isocyanate ratio may result in changes to the process for making the polyurethane composites. High filler loading in such systems typically inhibits (i.e., physically blocks) the reaction or action of the various polyurethane composite components, including the polyol, the isocyanate, the surfactants, the coupling agents, and the catalysts. Increasing the temperature during processing sometimes helps the reactivity of the reactive mixtures. The use of excess isocyanate, i.e., an isocyanate index above 100, can give higher temperature exotherms during the process of making the polyurethane composite material, which can result in more cross linking of the polyol and isocyanate, and/or a more complete reaction of the hydroxyl groups and isocyanate groups.

An example of useful compositional ranges (in percent based on the total composite composition) are provided below:

| Component | wt % range |
|---|---|
| Polyol | about 2.5 to about 35 |
| Isocyanate | about 2.5 to about 40 |
| Catalyst | up to about 0.3 |
| Surfactant | up to about 0.5 |
| Coupling | about 0.01 to about 0.5 |
| Agent | |
| Blowing | up to about 0.5 |
| Agent | |
| Pigment | up to about 7 |
| Fiber | up to about 10 |
| Filler | about 20 to about 95 |

Additional components as described herein can be added in various amounts that can be determined by persons having ordinary skill in the art.

The present invention is not limited in scope by the embodiments disclosed herein which are intended as illustrations of a few aspects of the invention and any embodiments which are functionally equivalent are within the scope of this invention. Various modifications of the apparatus and methods in addition to those shown and described herein will become apparent to those skilled in the art and are intended to fall within the scope of the appended claims. Further, while only certain representative combinations of the apparatus and method steps disclosed herein are specifically discussed in the embodiments above, other combinations of the apparatus components and method steps will become apparent to those skilled in the art and also are intended to fall within the scope of the appended claims. Thus a combination of components or steps may be explicitly mentioned herein; however, other combinations of components and steps are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

What is claimed is:

1. A method of forming a composite material in an extruder, the method comprising:
introducing a polymeric material and an inorganic filler to the extruder;
introducing a fiber to the extruder through a fiber metering device, the rate the fiber is introduced to the extruder being controlled by the fiber metering device to be proportional to an extrusion rate of the extruder; and
mixing the polymeric material, the inorganic filler, and the fiber in the extruder to produce a composite material.

2. The method of claim 1, wherein the extrusion rate is estimated based on the rotational velocity of a screw of the extruder.

3. The method of claim 1, wherein the extrusion rate is estimated based on the rate the polymeric material and inorganic filler materials advance through the extruder.

4. The method of claim 1, wherein the extrusion rate is estimated based on the rate the polymeric composite material exits the extruder.

5. The method of claim 1, wherein the extrusion rate is estimated based on the rate the polymeric material and inorganic filler materials are added to the extruder.

6. The method of claim 1, wherein the fiber metering device is a pulley.

7. The method of claim 6, wherein the rate the fiber is introduced to the extruder is determined based on the rotational speed of the pulley.

8. The method of claim 1, wherein the fiber metering device includes a motor.

9. The method of claim 1, wherein the polymeric material and inorganic filler are introduced through metering devices.

10. The method of claim 1, wherein the fiber metering device is controlled by a controller.

11. The method of claim 10, wherein the controller controls a fiber feed pulley.

12. The method of claim 10, wherein the controller controls a fiber feed motor.

13. The method of claim 10, wherein the controller controls a fiber feed retarder.

14. The method of claim 10, wherein the controller controls the fiber metering device based on an input signal, the input signal indicating an extrusion rate.

15. The method of claim 1, wherein the composite material is a polyurethane.

16. A method of forming a composite material in an extruder, the method comprising:
introducing a polymeric material and an inorganic filler to the extruder;
introducing a fiber to the extruder downstream of the polymeric material and inorganic filler, and controlling the rate the fiber is introduced to the extruder with a fiber metering device, the fiber metering device providing a constant weight percentage of fiber in the composite material based on the amount of polymeric material and inorganic filler introduced to the extruder; and
mixing the polyol, the polymeric material, the inorganic filler, and the fiber in the extruder to produce a composite material.

17. The method of claim 16, wherein the rate the fiber is introduced to the extruder is determined based on loss of weight of a fiber source.

18. The method of claim 16, wherein the fiber metering device is a pulley.

19. The method of claim 18, wherein the rate the fiber is introduced to the extruder is determined based on the rotational speed of the pulley.

20. The method of claim 16, wherein the fiber metering device includes a motor.

21. The method of claim 16, wherein the polymeric material and inorganic filler are introduced through metering devices.

22. The method of claim 16, wherein the fiber metering device is controlled by a controller.

23. The method of claim 22, wherein the controller controls a fiber feed pulley.

24. The method of claim 22, wherein the controller controls a fiber feed motor.

25. The method of claim 22, wherein the controller controls a fiber feed retarder.

26. The method of claim 22, wherein the controller controls the fiber metering device based on an input signal, the input signal indicating the amount of polymeric material and inorganic filler being introduced to the extruder.

27. The method of claim 16, wherein the composite material is a polyurethane.
